(19) United States
(12) Patent Application Publication
(10) Pub. No.: US 2025/0071611 A1
(43) Pub. Date: Feb. 27, 2025

(54) METHODS AND APPARATUS FOR COLLISION AND ABNORMAL CASES FOR PROXIMITY SERVICES

(71) Applicant: SAMSUNG ELECTRONICS CO., LTD., Suwon-si, Gyeonggi-do (KR)

(72) Inventors: Mahmoud WATFA, Staines, Middlesex (GB); Lalith KUMAR, Bangalore (IN); Mehrdad SHARIAT, Staines, Middlesex (GB)

(21) Appl. No.: 18/727,054

(22) PCT Filed: Jan. 4, 2023
(86) PCT No.: PCT/KR2023/000168

§ 371 Date: Jul. 5, 2024

(30) Foreign Application Priority Data
Jan. 5, 2022 (IN) 202231000645
Jan. 3, 2023 (GB) 2300020.1

(51) Int. Cl. H04W 28/02; H04W 24/10

(52) U.S. Cl. CPC H04W 28/0289; H04W 24/10

(57) ABSTRACT

The disclosure relates to a 5G or 6G communication system for supporting a higher data transmission rate. Disclosed is a method of operating Proximity Services, ProSe, in a wireless communication system, wherein an entity in the wireless communication system is in communication with a User Equipment, UE, wherein if the entity receives a Remote UE Report message for which a Protocol Data Unit, PDU, session ID in the Remote UE Report message belongs to any PDU session in state PDU SESSION INACTIVE in the entity, the entity includes a 5GSM cause Information Element, IE, in a REMOTE UE REPORT RESPONSE message and sets the 5GSM cause IE to a predetermined value in the REMOTE UE REPORT RESPONSE message.

### TECHNICAL FIELD

The present invention relates to Proximity Services, ProSe, in a wireless communication system. It relates particularly, but not exclusively, to a Fifth Generation, 5G, or New Radio, NR, network, but may apply to any suitable network.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end Al support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

According to a first aspect of the present invention, there is provided a method of operating Proximity Services, ProSe, in a wireless communication system, wherein an entity in the wireless communication system is in communication with a User Equipment, UE, wherein if the entity receives a Remote UE Report message for which a Protocol Data Unit, PDU, session ID in the Remote UE Report message belongs to any PDU session in state PDU SESSION INACTIVE in the entity, the entity includes a 5GSM cause Information Element, IE, in a REMOTE UE REPORT RESPONSE message and sets the 5GSM cause IE to a predetermined value in the REMOTE UE REPORT RESPONSE message.

### Advantageous Effects of Invention

According to an embodiment of the present invention, a method and apparatus for Proximity Services, ProSe, in a wireless communication system is provided.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a figure and table known in the prior art relating to a certain IE;

FIG. 2 shows a message format according to an embodiment of the invention;

FIG. 3 shows a message format according to an embodiment of the invention;

FIG. 4 shows a message format according to an embodiment of the invention;

FIG. 5 shows a message format according to an embodiment of the invention;

FIG. 6 shows a message format according to an embodiment of the invention;

FIG. 7 shows a message format according to an embodiment of the invention; and

FIG. 8 shows a message format according to an embodiment of the invention.

FIG. 9 is a block diagram of an internal configuration of a base station, according to an embodiment as disclosed herein.

FIG. 10 is a block diagram showing an internal structure of a terminal, according to an embodiment as disclosed herein.

### BEST MODE FOR CARRYING OUT THE INVENTION

According to the present invention there is provided an apparatus and method as set forth in the appended claims. Other features of the invention will be apparent from the dependent claims, and the description which follows.

According to a first aspect of the present invention, there is provided a method of operating Proximity Services, ProSe, in a wireless communication system, wherein an entity in the wireless communication system is in communication with a User Equipment, UE, wherein if the entity receives a Remote UE Report message for which a Protocol Data Unit, PDU, session ID in the Remote UE Report message belongs to any PDU session in state PDU SESSION INACTIVE in the entity, the entity includes a 5GSM cause Information Element, IE, in a REMOTE UE REPORT RESPONSE message and sets the 5GSM cause IE to a predetermined value in the REMOTE UE REPORT RESPONSE message.

In an embodiment, the entity is a Session Management Function, SMF.

In an embodiment, the predetermined value is #43 “Invalid PDU session identity”

In an embodiment, the entity then sends the REMOTE UE REPORT RESPONSE message

According to a second aspect of the present invention, there is provided a method of operating Proximity Services, ProSe, in a wireless communication system, wherein a first User Equipment, UE, operating as a UE to network relay, notifies the network, using a remote UE report procedure, that a second UE is connected to, or disconnected from, the first UE, unless a predetermined timer is running, in which case the first UE does not initiate the remote UE report procedure.

In an embodiment, the predetermined timer is one of T3396, T3584 and T3585.

According to a third aspect of the present invention, there is provided a method of operating Proximity Services, ProSe, in a wireless communication system, wherein if a User Equipment, UE, connected to the network, receives a PDU SESSION RELEASE COMMAND message during a remote UE report procedure, and a PDU session indicated in the PDU SESSION RELEASE COMMAND message is the same PDU session that the UE had indicated in the REMOTE UE REPORT message, the UE acts to abort the remote UE report procedure and proceeds with a network-requested PDU session release procedure.

According to a fourth aspect of the present invention, there is provided a method of operating Proximity Services, ProSe, in a wireless communication system, wherein if an entity in the wireless communication system receives a REMOTE UE REPORT message during a network-requested PDU session release procedure, and a PDU session indicated in the PDU SESSION RELEASE COMMAND message is the same PDU session that is in the REMOTE UE REPORT message, the entity acts to abort the remote UE report procedure and proceeds with the network-requested PDU session release procedure.

In an embodiment, the entity is a Session Management Function.

According to a fifth aspect of the present invention, there is provided a method of operating Proximity Services, ProSe, in a wireless communication system, wherein If a Remote UE Report message contains a PDU session ID which is invalid, a Session Management Function, SMF, in the wireless communication system sends a 5GSM STATUS message with a 5GSM cause value #43, “Invalid PDU session identity”, to a connected UE

In an embodiment, the wireless communication system or a connected UE are operable in one of S1 and N1 mode. The precise message details will differ as set out in the description.

According to a sixth aspect of the present invention, there is provided apparatus arranged to perform the method of any preceding aspect.

Although a few preferred embodiments of the present invention have been shown and described, it will be appreciated by those skilled in the art that various changes and modifications might be made without departing from the scope of the invention, as defined in the appended claims.

### Mode for the Invention

Before undertaking the description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Proximity services enable direct communications between devices where these devices can engage in ProSe discovery and/or ProSe communications using so called PC5 resources.

One of the use cases of ProSe is to provide relay services to so called remote User Equipments, UEs. A remote UE is a UE that is not in direct coverage of the network, whereas a relay UE is in coverage of the network and hence acts as a communication relay for the remote UEs. A Layer 3 UE-to-Network relay UE provides connectivity for remote UEs by establishing a Protocol Data Unit, PDU, session that is used for relay communication. More details about ProSe services can be found in the 3GPP specification TS 23.304 amongst other specifications.

Normally, when at least one remote UE uses a Layer-3 UE-to-network relay, the latter will send a report to the network to indicate the number of remote UEs that are being served by the Layer-3 UE-to-network relay.

In general, all the 5GSM procedures that are defined in 3GPP specification TS 24.501 are applicable for the case of a Layer-3 UE-to-Network relay.

Hereafter, the term ‘relay UE’ may refer to any type of relay UE e.g. a Layer-3 UE-to-network relay UE or a Layer-2 relay UE.

When the network experiences congestion, the network applies some congestion control mechanisms such as providing back-off (BO) timers to the UE which prevent most signalling from being sent from the UE with a few exceptions, until the BO timer expires or until the network sends a downlink message to the UE which signals the end of congestion. Most of the existing 5GSM procedures (in N1 mode, and ESM procedures in S1 mode) are subject to BO timers. The type of BO timer that is provided by the network to the UE depends on the reason for congestion e.g. T3396 is provided to the UE when the network wants to control congestion on the Data Network Name, DNN, level. Other BO timers include: T3584 which is related to slice and DNN level congestion, and T3585 which is related to slice level congestion. Note that a slice may be referred to by an S-NSSAI (see TS 24.501).

The Request type Information Element, IE, is an IE that is sent in the UL NAS TRANSPORT message which carries a 5GSM message. The value of the IE indicates the type of 5GSM message that is carried. The following is from TS 24.501 which details the encoding of this IE:

9.11.3.47 Request type

The purpose of the Request type information element is to indicate the type of the 5GSM message.

The Request type information element is coded as shown in FIG. 9.11.3.47.1 and table 9.11.3.47.1.

The Request type is a type 1 information element.

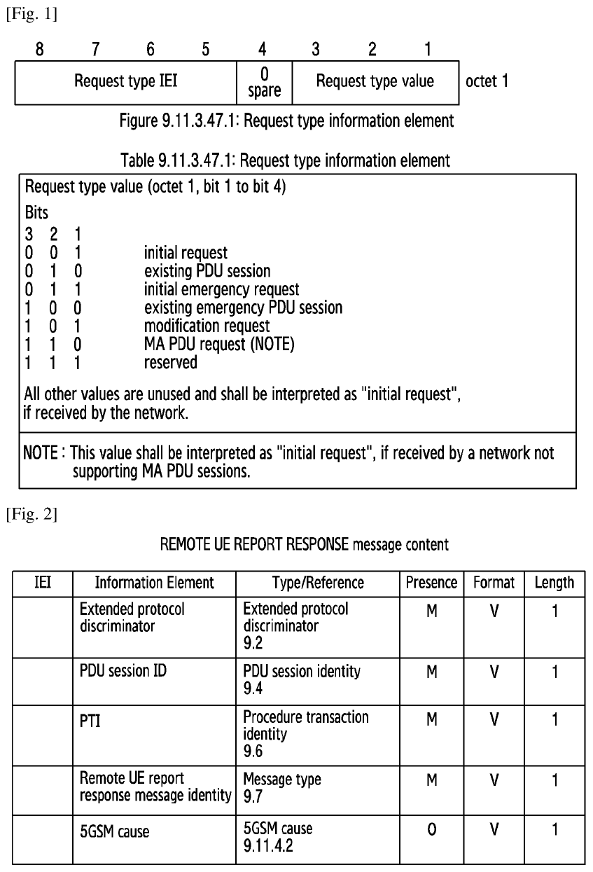

Note that FIG. 9.11.3.47.1 and Table 9.11.3.47.1 from TS 24.501 are shown in FIG. 1 of the accompanying drawings.

For example, when the UE sends a PDU Session Establishment Request message, the UE will set the Request type IE to ‘initial request’, and so on. However, the IE is omitted if the UE is sending a 5GSM message for the release of a PDU session (i.e. the PDU Session Release Request message).

The prior art experiences at least one problem. One such problem concerns collision between Remote UE Report Procedure & PDU Session Release Procedure. It is possible that the relay UE sends a Remote UE Report message to a Session Management Function, SMF, which happens to also send a PDU Session Release Request to the UE. In this case there is a collision of procedures for which the current specification in TS 24.501 has no defined behaviour. As such, both the UE and SMF behaviour need to be defined to handle such procedural collision otherwise the result will be undetermined and unspecified as different UEs and different SMFs may behave differently leading to undesired results. An over-riding aim in a wireless communication system is that unexpected behaviour is to be avoided.

Note that a similar problem exists for the case of S1 mode i.e. for ProSe in Evolved Packet System, EPS.

A second problem relates to an abnormal case for the Remote UE Report Procedure. Abnormal cases are normally defined in TS 24.501 for several procedures including those that are related to the 5GSM aspects. For example, the UE may send a PDU Session Modification Request message, or a PDU Session Release Request message, for which the SMF considers the PDU session ID to be associated with a PDU session in state PDU SESSION INACTIVE in the SMF i.e. the PDU session ID that the UE indicates does not point to a PDU session which is active in the SMF. This is thus considered to be an abnormal case.

If the procedure in question is a PDU session modification procedure, then the SMF behaves as follows as defined in section 6.4.2.6 of TS 24.501:

“b) PDU session inactive for the received PDU session identity.

If the PDU session ID in the PDU SESSION MODIFICATION REQUEST message belongs to any PDU session in state PDU SESSION INACTIVE in the SMF, the SMF shall set the 5GSM cause IE to #43 “Invalid PDU session identity” in the PDU SESSION MODIFICATION REJECT message.”

Similarly, the SMF behaves as shown below, from section 6.4.3.6 of TS 24.501, when the same abnormal case occurs during the PDU session release procedure:

“a) PDU session inactive for the received PDU session identity.

If the PDU session ID in the PDU SESSION RELEASE REQUEST message belongs to any PDU session in state PDU SESSION INACTIVE in the SMF, the SMF shall send the PDU SESSION RELEASE REJECT message to the UE with the 5GSM cause #43 “Invalid PDU session identity”.

As can be seen, the PDU session ID that the UE includes in a 5GSM message may be considered to be related to an inactive PDU session. This issue can also occur for the remote UE report procedure, however the problem is that such behaviour at the SMF is not defined. This means that if the PDU session ID that is included in the Remote UE Report message is indeed deemed to be associated with an inactive PDU session (i.e. the PDU session ID is for a PDU session that is in state PDU SESSION INACTIVE in the SMF), then there is no current defined behaviour that would permit the SMF to indicate so the UE. In fact, the SMF has no other option currently but to accept the message, although the information provided points to an inactive PDU session. This consequently means that there is no actual context in the SMF for such a PDU session and this renders the 5GSM procedures that may consequently be sent as void.

Therefore, a new SMF behaviour is required to deal with this abnormal case for the remote UE report procedure.

Note that a similar problem exists for the case of S1 mode i.e. for ProSe in EPS. A third problem relates to a lack of descriptions about the applicability of congestion control to remote UE reporting procedures. While congestion control can apply to most session management procedures, there are no descriptions about whether or not it applies to remote UE report procedure and, if so, how the network can provide a BO timer to the UE. There is a need to resolve this as there is no method by which the network can apply congestion control to this procedure.

In relation to the first mentioned problem, namely a collision between Remote UE Report Procedure & PDU Session Release Procedure, an embodiment of the invention provides handling at the UE and network side for collision of network-requested PDU session release and (UE-initiated) 5G ProSe remote UE report procedure. Note that this is for N1 mode while the solution for S1 mode will be presented hereafter.

If the UE receives a PDU SESSION RELEASE COMMAND message during the 5G ProSe remote UE report procedure (e.g. after the UE has sent the Remote UE Report message), and the PDU session (ID) indicated in the PDU SESSION RELEASE COMMAND message is the PDU session that is indicated (or included) in the Remote UE Report message, the UE shall abort the 5G ProSe remote UE report procedure and proceed with the network-requested PDU session release procedure.

If the SMF receives the Remote UE Report message during a network-initiated PDU session release procedure (e.g. after the SMF has sent the PDU SESSION RELEASE COMMAND message), and the PDU session (ID) indicated in the PDU SESSION RELEASE COMMAND message is the PDU session that is indicated (or included) in the Remote UE Report message, the SMF shall abort the 5G ProSe remote UE report procedure and proceed with the (network-requested) PDU session release procedure.

For S1 mode, a similar solution is provided, as follows.

If the UE receives a DEACTIVATE EPS BEARER CONTEXT REQUEST message during the remote UE report procedure (e.g. after the UE has sent the Remote UE Report message), and the EPS bearer identity (that is associated with the PDN) in the DEACTIVATE EPS BEARER CONTEXT REQUEST message is that of the default EPS bearer, then the UE shall abort the remote UE report procedure and proceed with the EPS bearer context deactivation procedure.

If the UE receives a DEACTIVATE EPS BEARER CONTEXT REQUEST message during the remote UE report procedure (e.g. after the UE has sent the Remote UE Report message), and the EPS bearer identity (that is associated with the PDN) in the DEACTIVATE EPS BEARER CONTEXT REQUEST message is not that of the default EPS bearer (i.e. the indicated EPS bearer identity is for a dedicated EPS bearer), then the UE may/should continue processing both the remote UE report procedure and EPS bearer context deactivation procedure i.e. both procedures are process/progressed at the same time.

If the Mobility Management Entity, MME, receives the Remote UE Report message during a network-initiated EPS bearer context deactivation procedure (e.g. after the network or MME has sent the DEACTIVATE EPS BEARER CONTEXT REQUEST message), and the EPS bearer identity (that is associated with the PDN) in the DEACTIVATE EPS BEARER CONTEXT REQUEST message is that of the default EPS bearer, then the MME shall abort the remote UE report procedure and proceed with the (network-initiated) EPS bearer context deactivation procedure.

If the MME receives the Remote UE Report message during a network-initiated EPS bearer context deactivation procedure (e.g. after the network or MME has sent the DEACTIVATE EPS BEARER CONTEXT REQUEST message), and the EPS bearer identity (that is associated with the PDN) in the DEACTIVATE EPS BEARER CONTEXT REQUEST message is not that of the default EPS bearer (i.e. the EPS bearer identity is for a dedicated EPS bearer), then the MME may or should continue processing both the remote UE report procedure and EPS bearer context deactivation procedure i.e. both procedures are processed or progressed at the same time.

In summary, the solution that is provided is as follows, and would apply to the UE (which may be in S1 mode or N1 mode) and the network (which may be an MME in the case of S1 mode, or an SMF in the case of N1 mode):
During a remote UE report procedure, if the UE receives a NAS message to deactivate or release a PDN connection or PDU session, then the UE may abort the remote UE report procedure and proceeds with the deactivation/release procedure of the PDN connection or PDU session
During a remote UE report procedure, if the UE receives a NAS message that is not related to the release of the PDN connection or PDU session, then the UE may progress both procedures
During a network initiated procedure to release a PDU session or deactivate a PDN connection, if the network receives a remote UE report message, then the network aborts the remote UE report procedure and proceeds with the release procedure of the PDU session or with the deactivation procedure of the PDN connection

During a network initiated procedure that is not related to the release of a PDU session or the deactivation of a PDN connection, if the network receives a remote UE report message, then the network can proceed with both the procedures
Note that the details above also apply for the case of a UE initiated request to release (or deactivate) a PDU session, a PDN connection, or an EPS bearer, which the UE may have initiated after initiating a remote UE report procedure. As such all the details above apply regardless of which entity initiates the procedure, and they would apply in S1 mode or N1 mode

In relation to the second mentioned problem, namely the abnormal case for the Remote UE Report Procedure, an embodiment of the invention defines the SMF behaviour when it receives a Remote UE Report message with a PDU session ID that points to a PDU session that is in state PDU SESSION INACTIVE in the SMF.

When the SMF receives a Remote UE Report message for which the PDU session ID in the Remote UE Report message belongs to any PDU session in state PDU SESSION INACTIVE in the SMF, the SMF should include the 5GSM cause IE in the REMOTE UE REPORT RESPONSE message and set the 5GSM cause IE to #43 “Invalid PDU session identity” in the REMOTE UE REPORT RESPONSE message. The SMF should then send the message to the UE.

Note that the 5GSM cause value IE is defined to be an optional IE in the message as shown in the table in FIG. 2, noting that the prior art format of the message does not contain this field.

When sending the Remote UE Report Response message, the SMF should include the same PDU session ID that was received (in the Remote UE Report message) and which was considered to be associated with a PDU session in state PDU SESSION INACTIVE in the SMF.

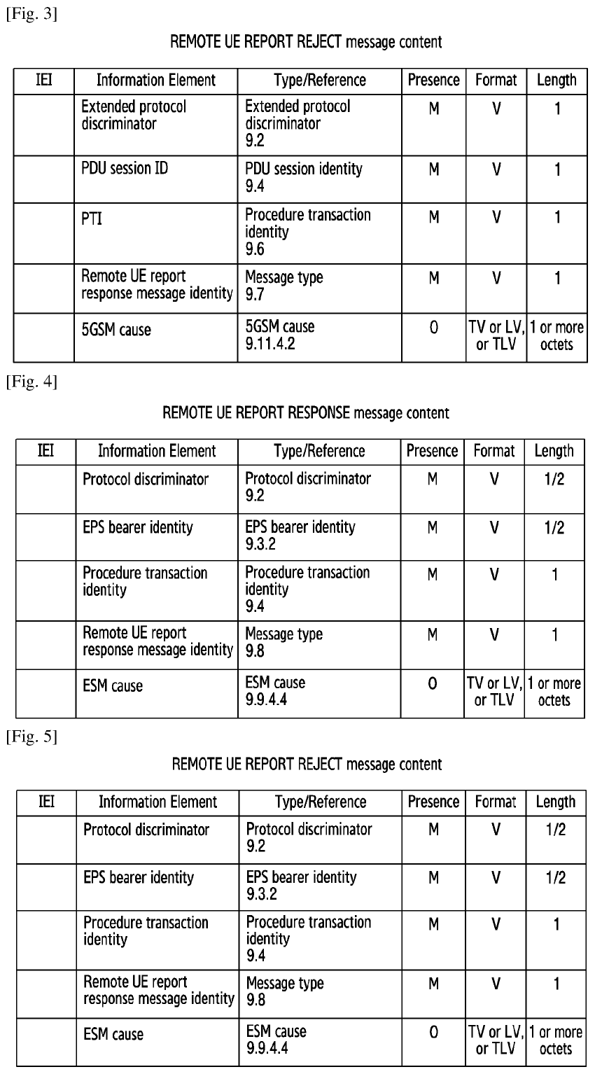

Alternatively, the SMF can send a new message e.g. Remote UE Report Reject message and include the 5GSM cause IE to #43 “Invalid PDU session identity”. The SMF also includes the same PDU session ID that was received (in the Remote UE Report message) and which was considered to be associated with a PDU session in state PDU SESSION INACTIVE in the SMF. The new message is shown in FIG. 3.

Note that the SMF may send the Remote UE Report Response message when no issue is detected with the message content or no other abnormal case is identified. On the other hand, the SMF may send the REMOTE UE REPORT REJECT message when any abnormal case is identified such as, but not limited to, the one set out herein.

Alternatively, when the above abnormal case happens at the SMF, the SMF should send the 5GSM STATUS message and include the 5GSM cause IE and set the IE to the value #43 “invalid PDU session identity”, where the PDU session ID that is included in the message should be the ID that is deemed to be invalid by the SMF (optionally where the PDU session ID that is included by the SMF is the one that was received in the Remote UE Report message and that was deemed to be invalid or associated with a non-active PDU session).

When the UE receives a Remote UE Report Response message, or a REMOTE UE REPORT REJECT message, or a 5GSM STATUS message, with the 5GSM cause IE included and the IE indicates #43 “Invalid PDU session identity”, then the UE may take any of the following actions:
The UE may send the Remote UE Report message again and set the PDU session ID accordingly (i.e. to reflect/identify the PDU session for which the UE wants to send the report)
The UE may initiate the PDU session release procedure by sending the PDU Session Release Request message and optionally set the PDU session ID to the PDU session ID that was indicated to be invalid, optionally only if the PDU session ID that is considered to be invalid is the same as the PDU session ID for which the first (or initial) Remote UE Report message was sent
The UE may locally release the PDU session identified by the PDU session ID that is included in the 5GSM Status message (optionally with the 5GSM cause value #43)

Note that the solutions set out above are also applied in S1 mode with the corresponding messages and/or ESM causes and for which the MME is considered to be the network entity instead of the SMF.

As such, when the MME receives a Remote UE Report message for which the EPS bearer identity in the Remote UE Report message does not belong to any already activated EPS bearer context (or the EPS bearer identity is for an EPS bearer a that is inactive), then the MME should include the ESM cause IE in the REMOTE UE REPORT RESPONSE message and set the ESM cause IE to #43 “Invalid EPS bearer identity” in the REMOTE UE REPORT RESPONSE message. The MME should then send the message to the UE.

Note that the ESM cause value IE should be defined to be an optional IE in the message as shown in FIG. 4, noting that the prior art format of the message does not contain this field.

When sending the Remote UE Report Response message, the MME should include the same EPS bearer identity that was received (in the Remote UE Report message) and which was considered to be associated with an EPS bearer that is not active (or that is associated with an EPS bearer context that is inactive) in the MME.

Alternatively, the MME can send a new message e.g. Remote UE Report Reject message and include the ESM cause IE to #43 “Invalid EPS bearer identity”. The MME also includes the same EPS bearer identity that was received (in the Remote UE Report message) and which was considered to be associated with an EPS bearer that is not active (or that is inactive) in the MME. The new message is shown in FIG. 5.

Note that the MME may send the Remote UE Report Response message when no issue is detected with the message content or no other abnormal case is identified. On the other hand, the MME may send the REMOTE UE REPORT REJECT message when any abnormal case is identified such as, but not limited to, the one set out herein.

Alternatively, when the above abnormal case happens at the MME, the MME should send the ESM STATUS message and include the ESM cause IE and set the IE to the value #43 “invalid EPS bearer identity”, where the EPS bearer ID that is included in the message should be the ID that is deemed to be invalid by the MME (optionally where the EPS bearer ID that is included by the MME is the one that was received in the Remote UE Report message and that was deemed to be inactive).

When the UE receives a Remote UE Report Response message, or a REMOTE UE REPORT REJECT message, or the ESM STATUS message, with the ESM cause IE included and the IE indicates #43 “Invalid EPS bearer identity”, then the UE may take any of the following actions:
The UE may send the Remote UE Report message again and set the EPS bearer ID accordingly (i.e. to reflect/identify the EPS bearer context/ID for which the UE wants to send the report)
The UE may initiate the deactivation of the EPS bearer by sending the BEARER RESOURCE MODIFICATION REQUEST message, or may initiate the PDN disconnection procedure by sending the PDN DISCONNECT REQUEST message, and optionally set the EPS bearer ID to represent the EPS bearer context/ID that was indicated to be invalid, optionally only if EPS bearer ID that is considered to be invalid is the same as the EPS bearer ID for which the first (or initial) Remote UE Report message was sent
The UE may locally deactivate the PDN connection that is identified by the EPS bearer ID which is received in the ESM STATUS message (optionally with the ESM cause value 43). The UE may do so if the EPS bearer is a default EPS bearer or a dedicated EPS bearer

In relation to the third mentioned problem, namely a lack of descriptions about the applicability of congestion control to remote UE reporting procedures, an embodiment of the invention provides a definition of suitable behaviour for back-off timer with regards to remote UE report.

As mentioned previously, there is no defined behaviour regarding the applicability of back-off (BO) timer to the remote UE report procedure. As such, in the prior art, it remains unclear how different UEs will behave with respect to the remote UE report when a BO timer is started.

To address this, several solutions are herein provided.

Option 1: any 5GSM BO timer (in N1 mode), or any ESM BO timer (in S1 mode), that is started should also be applicable to the remote UE report procedure.

Note that the term BO timer hereafter can refer to any of the 5GSM BO timers (e.g. T3396, T3584, or T3585) or any ESM BO timer e.g. T3396. The titles used for the timers are those known in the art, but other timers may be defined or used as appropriate.

As such, when the UE wants to send a Remote UE Report message (either in S1 mode or N1 mode) the UE should verify if any BO timer is running. If yes, then the UE should not send the NAS message (i.e. Remote UE Report message). If the BO timer is not running, then the UE can send the message. As such, the UE should now consider the BO timer in order to determine if the Remote UE Report message should be sent or not as explained.

If the BO timer is running and the UE needs to send the Remote UE Report message, then the UE should wait until the timer is either stopped or it expires. Upon the expiry of the BO timer, or when the BO timer is stopped, then the UE should send the Remote UE Report message.

Furthermore, the network may send a BO timer to the UE when it sends the Remote UE Report message.

The SMF may send a 5GSM BO timer in the Remote UE Response message, optionally with a 5GSM cause value to indicate that the reason is due to congestion. These IEs can be included as optional fields in the Remote UE Report message. Alternatively, a new 5GSM message can be used when the SMF applies congestion control during the remote UE report procedure. For example, the Remote UE Report Reject message (as defined above) can also be used for this purpose. Additionally, this new message may include a BO timer (e.g. the Back-off timer value IE that is defined in TS 24.501) and optionally a 5GSM cause IE (see TS 24.501) to indicate the reason for sending the BO timer e.g. due to congestion.

When the UE receives either a Remote UE Response message, or a Remote UE Report Reject message, with a BO timer value, the UE should start the corresponding BO timer based on the 5GSM cause value, i.e.:
The UE starts T3396 with the value indicated in the received BO timer if the 5GSM cause value is 5GSM cause value #26 “insufficient resources”,
The UE starts T3584 with the value indicated in the received BO timer if the 5GSM cause value is 5GSM cause value #67 “insufficient resources for specific slice and DNN”,

The UE starts T3585 with the value indicated in the received BO timer if the 5GSM cause value is 5GSM cause value #69 “insufficient resources for specific slice”

Note that the UE handles the received BO timer as shown below:

If:
the 5GSM cause value #26 “insufficient resources” and the Back-off timer value IE are included in the Remote UE Report message or the Remote UE Report Reject message; or

an indication that the 5GSM message was not forwarded due to DNN based congestion control is received along a Back-off timer value and a Remote UE Report message, and optionally PDU session ID IE set to the PDU session ID of the PDU session;
the UE shall ignore the 5GSM congestion re-attempt indicator or the Re-attempt indicator IE provided by the network, if any, and the UE shall take different actions depending on the timer value received for timer T3396 in the Back-off timer value IE or depending on the Back-off timer value received from the 5GMM sublayer (if the UE is a UE configured for high priority access in selected PLMN, exceptions are specified in subclause 6.2.7):
a) If the timer value indicates neither zero nor deactivated and a DNN was provided during the PDU session establishment, the UE shall stop timer T3396 associated with the corresponding DNN, if it is running. If the timer value indicates neither zero nor deactivated and no DNN was provided during the PDU session establishment and the request type was different from “initial emergency request” and different from “existing emergency PDU session”, the UE shall stop timer T3396 associated with no DNN if it is running. The UE shall then start timer T3396 with the value provided in the Back-off timer value IE or with the Back-off timer value received from the 5GMM sublayer and:
1) shall not send another Remote UE Report message, or another 5GSM message, with exception of those identified in subclause 6.4.2.1, for the same DNN that was sent by the UE, until timer T3396 expires or timer T3396 is stopped; and
2) shall not send another Remote UE Report message, or another 5GSM message, without a DNN and with request type different from “initial emergency request” and different from “existing emergency PDU session”, or another PDU SESSION MODIFICATION REQUEST message with exception of those identified in subclause 6.4.2.1, for a non-emergency PDU session established without a DNN provided by the UE, if no DNN was provided during the PDU session establishment and the request type was different from “initial emergency request” and different from “existing emergency PDU session”, until timer T3396 expires or timer T3396 is stopped.

The UE shall not stop timer T3396 upon a PLMN change or inter-system change;
b) if the timer value indicates that this timer is deactivated and a DNN was provided during the PDU session establishment, the UE shall stop timer T3396 associated with the corresponding DNN, if it is running. If the timer value indicates that this timer is deactivated and no DNN was provided during the PDU session establishment and the request type was different from “initial emergency request” and different from “existing emergency PDU session”, the UE shall stop timer T3396 associated with no DNN if it is running. The UE:
1) shall not send another Remote UE Report message, for the same DNN until the UE is switched off, the USIM is removed, the entry in the “list of subscriber data” for the current SNPN is updated if the UE does not support access to an SNPN using credentials from a credentials holder, or the selected entry of the “list of subscriber data” is updated if the UE supports access to an SNPN using credentials from a credentials holder, or the UE receives a PDU SESSION MODIFICATION COMMAND message for the same DNN from the network, or a PDU SESSION AUTHENTICATION COMMAND message for the same DNN from the network, or a PDU SESSION RELEASE COMMAND message without the Back-off timer value IE for the same DNN from the network; and
2) shall not send another Remote UE Report message without a DNN and with request type different from “initial emergency request” and different from “existing emergency PDU session”, or another PDU SESSION MODIFICATION REQUEST message with exception of those identified in subclause 6.4.2.1, for a non-emergency PDU session established without a DNN provided by the UE, if no DNN was provided during the PDU session establishment and the request type was different from “initial emergency request” and different from “existing emergency PDU session”, until the UE is switched off, the USIM is removed, the entry in the “list of subscriber data” for the current SNPN is updated if the UE does not support access to an SNPN using credentials from a credentials holder, or the selected entry of the “list of subscriber data” is updated if the UE supports access to an SNPN using credentials from a credentials holder, or the UE receives a PDU SESSION MODIFICATION COMMAND message for a non-emergency PDU session established without a DNN provided by the UE, or a PDU SESSION AUTHENTICATION COMMAND message for a non-emergency PDU session established without a DNN provided by the UE, or a PDU SESSION RELEASE COMMAND message without the Back-off timer value IE for a non-emergency PDU session established without a DNN provided by the UE.

The timer T3396 remains deactivated upon a PLMN change or inter-system change; and
c) if the timer value indicates zero, the UE:
1) shall stop timer T3396 associated with the corresponding DNN, if running, and may send another PDU SESSION ESTABLISHMENT REQUEST message or PDU SESSION MODIFICATION REQUEST message or Remote UE Report message for the same DNN; and
2) if no DNN was provided during the PDU session establishment and the request type was different from “initial emergency request” and different from “existing emergency PDU session”, the UE shall stop timer T3396 associated with no DNN, if running, and may send another PDU SESSION ESTABLISHMENT REQUEST message without a DNN, or another PDU SESSION MODIFICATION REQUEST message without a DNN, or another Remote UE Report message without a DNN provided by the UE.

If the Back-off timer value IE is not included or no Back-off timer value is received from the 5GMM sublayer, then the UE may send another PDU SESSION ESTABLISHMENT REQUEST message or PDU SESSION MODIFICATION REQUEST message, or Remote UE Report message, for the same DNN or without a DNN.

When the timer T3396 is running or the timer is deactivated, the UE is allowed to initiate a PDU session establishment procedure for emergency services.

If the timer T3396 is running when the UE enters state 5GMM-DEREGISTERED, the UE remains switched on, and the USIM in the UE (if any) remains the same and the entry in the “list of subscriber data” to which timer T3396 is associated (if any) is not updated, then timer T3396 is kept running until it expires or it is stopped.

If the UE is switched off when the timer T3396 is running, and if the USIM in the UE (if any) remains the same and the entry in the “list of subscriber data” to which timer T3396 is associated (if any) is not updated when the UE is switched on, the UE shall behave as follows:
let t1 be the time remaining for T3396 timeout at switch off and let t be the time elapsed between switch off and switch on. If t1 is greater than t, then the timer shall be restarted with the value t1−t. If t1 is equal to or less than t, then the timer need not be restarted. If the UE is not capable of determining t, then the UE shall restart the timer with the value t1.

If:
the 5GSM cause value #67 “insufficient resources for specific slice and DNN” and the Back-off timer value IE are included in the Remote UE Report message, or Remote

UE Report Reject message; or
an indication that the 5GSM message was not forwarded due to S-NSSAI and DNN based congestion control is received along a Back-off timer value and a Remote UE Report message with the PDU session ID IE set to the PDU session ID of the PDU session;

the UE shall ignore the Re-attempt indicator IE provided by the network, if any, and take different actions depending on the timer value received for timer T3584 in the Back-off timer value IE or depending on the Back-off timer value received from the 5GMM sublayer (if the UE is a UE configured for high priority access in selected PLMN, exceptions are specified in subclause 6.2.8):
a) If the timer value indicates neither zero nor deactivated, the UE shall stop timer T3584 associated with the same [S-NSSAI, DNN] combination as that the UE provided during the PDU session establishment, if it is running. If the timer value indicates neither zero nor deactivated and no DNN was provided during the PDU session establishment and the request type was different from “initial emergency request” and different from “existing emergency PDU session”, the UE shall stop timer T3584 associated with [S-NSSAI, no DNN] combination as that the UE provided during the PDU session establishment, if it is running. If the timer value indicates neither zero nor deactivated and no S-NSSAI was provided during the PDU session establishment, the UE shall stop timer T3584 associated with [no S-NSSAI, DNN] combination as that the UE provided during the PDU session establishment, if it is running. If the timer value indicates neither zero nor deactivated and neither S-NSSAI nor DNN was provided during the PDU session establishment and the request type was different from “initial emergency request” and different from “existing emergency PDU session”, the UE shall stop timer T3584 associated with [no S-NSSAI, no DNN] combination as that the UE provided during the PDU session establishment, if it is running. The timer T3584 to be stopped includes the timer T3584 applied for all the PLMNs, if running, and the timer T3584 applied for the registered PLMN, if running. The UE shall then start timer T3584 with the value provided in the Back-off timer value IE or with the Back-off timer value received from the 5GMM sublayer and:
1) shall not send another PDU SESSION ESTABLISHMENT REQUEST message, or PDU SESSION MODIFICATION REQUEST message with exception of those identified in subclause 6.4.2.1, or another Remote UE Report message, for the same [S-NSSAI, DNN] combination that was sent by the UE, until timer T3584 expires or timer T3584 is stopped;
2) shall not send another PDU SESSION ESTABLISHMENT REQUEST message with request type different from “initial emergency request” and different from “existing emergency PDU session”, or another PDU SESSION MODIFICATION REQUEST with exception of those identified in subclause 6.4.2.1, or another Remote UE Report message for the same [S-NSSAI, no DNN] combination that was sent by the UE, if no DNN was provided during the PDU session establishment, until timer T3584 expires or timer T3584 is stopped;
3) shall not send another PDU SESSION ESTABLISHMENT REQUEST message, or another PDU SESSION MODIFICATION REQUEST message with exception of those identified in subclause 6.4.2.1, or another Remote UE Report message for the same [no S-NSSAI, DNN] combination that was sent by the UE, if no S-NSSAI was provided during the PDU session establishment, until timer T3584 expires or timer T3584 is stopped; and
4) shall not send another PDU SESSION ESTABLISHMENT REQUEST message with request type different from “initial emergency request” and different from “existing emergency PDU session”, or another PDU SESSION MODIFICATION REQUEST message with exception of those identified in subclause 6.4.2.1, or another Remote UE Report message for the same [no S-NSSAI, no DNN] combination that was sent by the UE, if neither S-NSSAI nor DNN was provided during the PDU session establishment, until timer T3584 expires or timer T3584 is stopped.

The UE shall not stop timer T3584 upon a PLMN change or inter-system change;
b) if the timer value indicates that this timer is deactivated, the UE:
1) shall stop timer T3584 associated with the same [S-NSSAI, DNN] combination as that the UE provided during the PDU session establishment (including the timer T3584 applied for all the PLMNs, if running, and the timer T3584 applied for the registered PLMN, if running), if it is running. The UE shall not send another PDU SESSION ESTABLISHMENT REQUEST message, or PDU SESSION MODIFICATION REQUEST message with exception of those identified in subclause 6.4.2.1, or another Remote UE Report message, for the same [S-NSSAI, DNN] combination that was sent by the UE, until the UE is switched off, the USIM is removed, the entry in the “list of subscriber data” for the current SNPN is updated if the UE does not support access to an SNPN using credentials from a credentials holder, or the selected entry of the “list of subscriber data” is updated if the UE supports access to an SNPN using credentials from a credentials holder, or the UE receives a PDU SESSION MODIFICATION COMMAND message for the same [S-NSSAI, DNN] combination from the network, or a PDU SESSION AUTHENTICATION COMMAND message for the same [S-NSSAI, DNN] combination from the network, or a PDU SESSION RELEASE COMMAND message without the Back-off timer value IE for the same [S-NSSAI, DNN] combination from the network;
2) shall stop timer T3584 associated with the same [S-NSSAI, no DNN] combination as that the UE provided during the PDU session establishment (including the timer T3584 applied for all the PLMNs, if running, and the timer T3584 applied for the registered PLMN, if running), if it is running. The UE shall not send a PDU SESSION ESTABLISHMENT REQUEST message with request type different from “initial emergency request” and different from “existing emergency PDU session”, or a PDU SESSION MODIFICATION REQUEST message with exception of those identified in subclause 6.4.2.1, or another Remote UE Report message for the same [S-NSSAI, no DNN] combination that was sent by the UE, if no DNN was provided during the PDU session establishment, until the UE is switched off, the USIM is removed, the entry in the “list of subscriber data” for the current SNPN is updated if the UE does not support access to an SNPN using credentials from a credentials holder, or the selected entry of the “list of subscriber data” if the UE supports access to an SNPN using credentials from a credentials holder, or the UE receives an PDU SESSION MODIFICATION COMMAND message for a non-emergency PDU session established for the same [S-NSSAI, no DNN] combination from the network, or a PDU SESSION AUTHENTICATION COMMAND message for a non-emergency PDU session established for the same [S-NSSAI, DNN] combination from the network, or a PDU SESSION RELEASE COMMAND message without the Back-off timer value IE for a non-emergency PDU session established for the same [S-NSSAI, no DNN] combination from the network;
3) shall stop timer T3584 associated with the same [no S-NSSAI, DNN] combination as that the UE provided during the PDU session establishment (including the timer T3584 applied for all the PLMNs, if running, and the timer T3584 applied for the registered PLMN, if running), if it is running. The UE shall not send a PDU SESSION ESTABLISHMENT REQUEST message, or a PDU SESSION MODIFICATION REQUEST message with exception of those identified in subclause 6.4.2.1, or another Remote UE Report message for the same [no S-NSSAI, DNN] combination that was sent by the UE, if no S-NSSAI was provided during the PDU session establishment, until the UE is switched off, the USIM is removed, the entry in the “list of subscriber data” for the current SNPN is updated, or the UE receives a PDU SESSION MODIFICATION COMMAND message for the same [no S-NSSAI, DNN] combination from the network, or a PDU SESSION AUTHENTICATION COMMAND message for a non-emergency PDU session established for the same [no S-NSSAI, no DNN] combination from the network, or a PDU SESSION RELEASE COMMAND message without the Back-off timer value IE for the same [no S-NSSAI, DNN] combination from the network; and
4) shall stop timer T3584 associated with the same [no S-NSSAI, no DNN] combination as that the UE provided during the PDU session establishment (including the timer T3584 applied for all the PLMNs, if running, and the timer T3584 applied for the registered PLMN, if running), if it is running. The UE shall not send a PDU SESSION ESTABLISHMENT REQUEST message with request type different from “initial emergency request” and different from “existing emergency PDU session”, or a PDU SESSION MODIFICATION REQUEST message with exception of those identified in subclause 6.4.2.1, or another Remote UE Report message, for the same [no S-NSSAI, no DNN] combination that was sent by the UE, if neither S-NSSAI nor DNN was provided during the PDU session establishment, until the UE is switched off, the USIM is removed, the entry in the “list of subscriber data” for the current SNPN is updated if the UE does not support access to an SNPN using credentials from a credentials holder, or the selected entry of the “list of subscriber data” is updated if the UE supports access to an SNPN using credentials from a credentials holder, or the UE receives an PDU SESSION MODIFICATION COMMAND message for a non-emergency PDU session established for the same [no S-NSSAI, no DNN] combination from the network or a PDU SESSION RELEASE COMMAND message without the Back-off timer value IE for a non-emergency PDU session established for the same [no S-NSSAI, no DNN] combination from the network.

The timer T3584 remains deactivated upon a PLMN change or inter-system change; and
c) if the timer value indicates zero, the UE:
1) shall stop timer T3584 associated with the same [S-NSSAI, DNN] combination as that the UE provided during the PDU session establishment (including the timer T3584 applied for all the PLMNs, if running, and the timer T3584 applied for the registered PLMN, if running), if it is running. The UE may send another PDU SESSION ESTABLISHMENT REQUEST message or PDU SESSION MODIFICATION REQUEST message, or Remote UE Report message, for the same [S-NSSAI, DNN] combination;
2) shall stop timer T3584 associated with the same [S-NSSAI, no DNN] combination as that the UE provided during the PDU session establishment (including the timer T3584 applied for all the PLMNs, if running, and the timer T3584 applied for the registered PLMN, if running), if it is running. The UE may send another PDU SESSION ESTABLISHMENT REQUEST message or PDU SESSION MODIFICATION REQUEST message, Remote UE Report message, for the same [S-NSSAI, no DNN] combination if no DNN was provided during the PDU session establishment and the request type was different from “initial emergency request” and different from “existing emergency PDU session”;
3) shall stop timer T3584 associated with the same [no S-NSSAI, DNN] combination as that the UE provided during the PDU session establishment (including the timer T3584 applied for all the PLMNs, if running, and the timer T3584 applied for the registered PLMN, if running), if it is running. The UE may send another PDU SESSION ESTABLISHMENT REQUEST message, or PDU SESSION MODIFICATION REQUEST message, or Remote UE Report message for the same [no S-NSSAI, DNN] combination if no NSSAI was provided during the PDU session establishment; and
4) shall stop timer T3584 associated with the same [no S-NSSAI, no DNN] combination as that the UE provided during the PDU session establishment (including the timer T3584 applied for all the PLMNs, if running, and the timer T3584 applied for the registered PLMN, if running), if it is running. The UE may send another PDU SESSION ESTABLISHMENT REQUEST message, or PDU SESSION MODIFICATION REQUEST message, or Remote UE Report message, for the same [no S-NSSAI, no DNN] combination if neither S-NSSAI nor DNN was provided during the PDU session establishment and the request type was different from “initial emergency request” and different from “existing emergency PDU session”.

If the 5GSM congestion re-attempt indicator IE set to “The back-off timer is applied in all PLMNs” is included in the PDU SESSION ESTABLISHMENT REJECT message with the 5GSM cause value #67 “insufficient resources for specific slice and DNN”, then the UE shall apply the timer T3584 for all the PLMNs. Otherwise, the UE shall apply the timer T3584 for the registered PLMN.

If the Back-off timer value IE is not included or no Back-off timer value is received from the 5GMM sublayer, then the UE may send another PDU SESSION ESTABLISHMENT REQUEST message or PDU SESSION MODIFICATION REQUEST message, or another Remote UE Report message, for the same [S-NSSAI, DNN] combination, or for the same [S-NSSAI, no DNN] combination, or for the same [no S-NSSAI, DNN] combination, or for the same [no S-NSSAI, no DNN] combination.

When the timer T3584 is running or the timer is deactivated, the UE is allowed to initiate a PDU session establishment procedure for emergency services.

If the timer T3584 is running when the UE enters state 5GMM-DEREGISTERED, the UE remains switched on, and the USIM in the UE (if any) remains the same and the entry in the “list of subscriber data” to which timer T3584 is associated (if any) is not updated, then timer T3584 is kept running until it expires or it is stopped.

If the UE is switched off when the timer T3584 is running, and if the USIM in the UE (if any) remains the same and the entry in the “list of subscriber data” to which timer T3584 is associated (if any) is not updated when the UE is switched on, the UE shall behave as follows:
let t1 be the time remaining for T3584 timeout at switch off and let t be the time elapsed between switch off and switch on. If t1 is greater than t, then the timer shall be restarted with the value t1−t. If t1 is equal to or less than t, then the timer need not be restarted. If the UE is not capable of determining t, then the UE shall restart the timer with the value t1.

If:
the 5GSM cause value #69 “insufficient resources for specific slice” and the Back-off timer value IE are included in the Remote UE Response message, or in the Remote UE Report Reject message; or
an indication that the 5GSM message was not forwarded due to S-NSSAI only based congestion control is received along a Back-off timer value and a Remote UE Report message with the PDU session ID IE set to the PDU session ID of the PDU session;

the UE shall ignore the Re-attempt indicator IE provided by the network, if any, and take different actions depending on the timer value received for timer T3585 in the Back-off timer value IE or depending on the Back-off timer value received from the 5GMM sublayer (if the UE is a UE configured for high priority access in selected PLMN, exceptions are specified in subclause 6.2.8):
a) If the timer value indicates neither zero nor deactivated and an S-NSSAI was provided during the PDU session establishment and the request type was different from “initial emergency request” and different from “existing emergency PDU session”, the UE shall stop timer T3585 associated with the corresponding S-NSSAI, if it is running. If the timer value indicates neither zero nor deactivated and no S-NSSAI was provided during the PDU session establishment and the request type was different from “initial emergency request” and different from “existing emergency PDU session”, the UE shall stop timer T3585 associated with no S-NSSAI if it is running. The timer T3585 to be stopped includes the timer T3585 applied for all the PLMNs, if running, and the timer T3585 applied for the registered PLMN, if running. The UE shall then start timer T3585 with the value provided in the Back-off timer value IE or with the Back-off timer value received from the 5GMM sublayer and:
1) shall not send another PDU SESSION ESTABLISHMENT REQUEST message with request type different from “initial emergency request” and different from “existing emergency PDU session”, or another PDU SESSION MODIFICATION REQUEST message with exception of those identified in subclause 6.4.2.1, or another Remote UE Report message, for a non-emergency PDU session for the same S-NSSAI that was sent by the UE, until timer T3585 expires or timer T3585 is stopped; and
2) shall not send another PDU SESSION ESTABLISHMENT REQUEST message without an S-NSSAI and with request type different from “initial emergency request” and different from “existing emergency PDU session”, or another PDU SESSION MODIFICATION REQUEST message with exception of those identified in subclause 6.4.2.1, or another Remote UE Report message, for a non-emergency PDU session established without an S-NSSAI provided by the UE, if no S-NSSAI was provided during the PDU session establishment and the request type was different from “initial emergency request” and different from “existing emergency PDU session”, until timer T3585 expires or timer T3585 is stopped.

The UE shall not stop timer T3585 upon a PLMN change or inter-system change;
b) if the timer value indicates that this timer is deactivated and an S-NSSAI was provided during the PDU session establishment and the request type was different from “initial emergency request” and different from “existing emergency PDU session”, the UE shall stop timer T3585 associated with the corresponding S-NSSAI, if it is running. If the timer value indicates that this timer is deactivated and no S-NSSAI was provided during the PDU session establishment and the request type was different from “initial emergency request” and different from “existing emergency PDU session”, the UE shall stop timer T3585 associated with no S-NSSAI if it is running. The timer T3585 to be stopped includes the timer T3585 applied for all the PLMNs, if running, and the timer T3585 applied for the registered PLMN, if running. The UE:
1) shall not send another PDU SESSION ESTABLISHMENT REQUEST message with request type different from “initial emergency request” and different from “existing emergency PDU session”, or another PDU SESSION MODIFICATION REQUEST with exception of those identified in subclause 6.4.2.1, or another Remote UE Report message, for a non-emergency PDU session for the same S-NSSAI until the UE is switched off, the USIM is removed, the entry in the “list of subscriber data” for the current SNPN is updated if the UE does not support access to an SNPN using credentials from a credentials holder, or the selected entry of the “list of subscriber data” is updated if the UE supports access to an SNPN using credentials from a credentials holder, or the UE receives a PDU SESSION MODIFICATION COMMAND message for a non-emergency PDU session for the same S-NSSAI from the network, or a PDU SESSION AUTHENTICATION COMMAND message for a non-emergency PDU session for the same S-NSSAI from the network, or a PDU SESSION RELEASE COMMAND message without the Back-off timer value IE for the same S-NSSAI from the network; and
2) shall not send another PDU SESSION ESTABLISHMENT REQUEST message without an S-NSSAI and with request type different from “initial emergency request” and different from “existing emergency PDU session”, or another PDU SESSION MODIFICATION REQUEST message with exception of those identified in subclause 6.4.2.1, or another Remote UE Report message, for a non-emergency PDU session established without an S-NSSAI provided by the UE, if no S-NSSAI was provided during the PDU session establishment and the request type was different from “initial emergency request” and different from “existing emergency PDU session”, until the UE is switched off, the USIM is removed, the entry in the “list of subscriber data” for the current SNPN is updated if the UE does not support access to an SNPN using credentials from a credentials holder, or the selected entry of the “list of subscriber data” is updated if the UE supports access to an SNPN using credentials from a credentials holder, or the UE receives a PDU SESSION MODIFICATION COMMAND message for a non-emergency PDU session established without an S-NSSAI provided by the UE, or a PDU SESSION AUTHENTICATION COMMAND message for a non-emergency PDU session established without an S-NSSAI provided by the UE, or a PDU SESSION RELEASE COMMAND message without the Back-off timer value IE for a non-emergency PDU session established without an S-NSSAI provided by the UE.

The timer T3585 remains deactivated upon a PLMN change or inter-system change; and
c) if the timer value indicates zero, the UE:
1) shall stop timer T3585 associated with the corresponding S-NSSAI (including the timer T3585 applied for all the PLMNs, if running, and the timer T3585 applied for the registered PLMN, if running), if running, and may send another PDU SESSION ESTABLISHMENT REQUEST message or PDU SESSION MODIFICATION REQUEST message, or may send another Remote UE Report message, for the same S-NSSAI; and
2) if no S-NSSAI was provided during the PDU session establishment and the request type was different from “initial emergency request” and different from “existing emergency PDU session”, the UE shall stop timer T3585 associated with no S-NSSAI, if running, and may send another PDU SESSION ESTABLISHMENT REQUEST message without an S-NSSAI (including the timer T3585 applied for all the PLMNs, if running, and the timer T3585 applied for the registered PLMN, if running), or another PDU SESSION MODIFICATION REQUEST message without an S-NSSAI provided by the UE, or another Remote UE Report message without an S-NSSAI provided by the UE.

If the 5GSM congestion re-attempt indicator IE set to “The back-off timer is applied in all PLMNs” is included in the PDU SESSION ESTABLISHMENT REJECT message with the 5GSM cause value #69 “insufficient resources for specific slice”, then the UE shall apply the timer T3585 for all the PLMNs. Otherwise, the UE shall apply the timer T3585 for the registered PLMN.

If the Back-off timer value IE is not included or no Back-off timer value is received from the 5GMM sublayer, then the UE may send another PDU SESSION ESTABLISHMENT REQUEST message or PDU SESSION MODIFICATION REQUEST message, or another Remote UE Report message, for the same S-NSSAI or without an S-NSSAI.

When the timer T3585 is running or the timer is deactivated, the UE is allowed to initiate a PDU session establishment procedure for emergency services.

If the timer T3585 is running when the UE enters state 5GMM-DEREGISTERED, the UE remains switched on, and the USIM in the UE (if any) remains the same and the entry in the “list of subscriber data” to which timer T3585 is associated (if any) is not updated, then timer T3585 is kept running until it expires or it is stopped.

If the UE is switched off when the timer T3585 is running, and if the USIM in the UE (if any) remains the same and the entry in the “list of subscriber data” to which timer T3585 is associated (if any) is not updated when the UE is switched on, the UE shall behave as follows:

let t1 be the time remaining for T3585 timeout at switch off and let t be the time elapsed between switch off and switch on. If t1 is greater than t, then the timer shall be restarted with the value t1−t. If t1 is equal to or less than t, then the timer need not be restarted. If the UE is not capable of determining t, then the UE shall restart the timer with the value t1.

Note that as described in this subclause, upon PLMN change or inter-system change, the UE does not stop the timer T3584 or T3585. This means the timer T3584 or T3585 can still be running or be deactivated for the given 5GSM procedure, the PLMN, the S-NSSAI and optionally the DNN combination when the UE returns to the PLMN or when it performs inter-system change back from S1 mode to N1 mode. Thus the UE can still be prevented from sending another PDU SESSION ESTABLISHMENT REQUEST or PDU SESSION MODIFICATION REQUEST message in the PLMN for the same S-NSSAI and optionally the same DNN.

Upon PLMN change, if T3584 is running or is deactivated for an S-NSSAI, a DNN, and old PLMN, but T3584 is not running and is not deactivated for the S-NSSAI, the DNN, and new PLMN, then the UE is allowed to send a PDU SESSION ESTABLISHMENT REQUEST message, or a Remote UE Report message, for the same S-NSSAI and the same DNN in the new PLMN.

Upon PLMN change, if T3585 is running or is deactivated for an S-NSSAI and old PLMN, but T3585 is not running and is not deactivated for the S-NSSAI and new PLMN, then the UE is allowed to send a PDU SESSION ESTABLISHMENT REQUEST message for the same S-NSSAI in the new PLMN.

Upon PLMN change, if T3585 is running or is deactivated for an S-NSSAI and old PLMN, but T3585 is not running and is not deactivated for the S-NSSAI and new PLMN, then the UE is allowed to send a Remote UE Report message for the same S-NSSAI in the new PLMN.

In order to enable the AMF to apply 5GSM level congestion control, it is proposed that, when the UE sends the Remote UE Report message as the 5GSM message that is carried in the UL NAS TRANSPORT message, then the UE should include the Request type IE in the UL NAS TRANSPORT message and set the value either to “modification request”, or a new value such as (noting this is just an example) “relay management” or “remote UE report”, or “remote UE management”, etc, or any other value that can be defined. It may be the case that a new value should be defined for L2 relay or L3 relay.

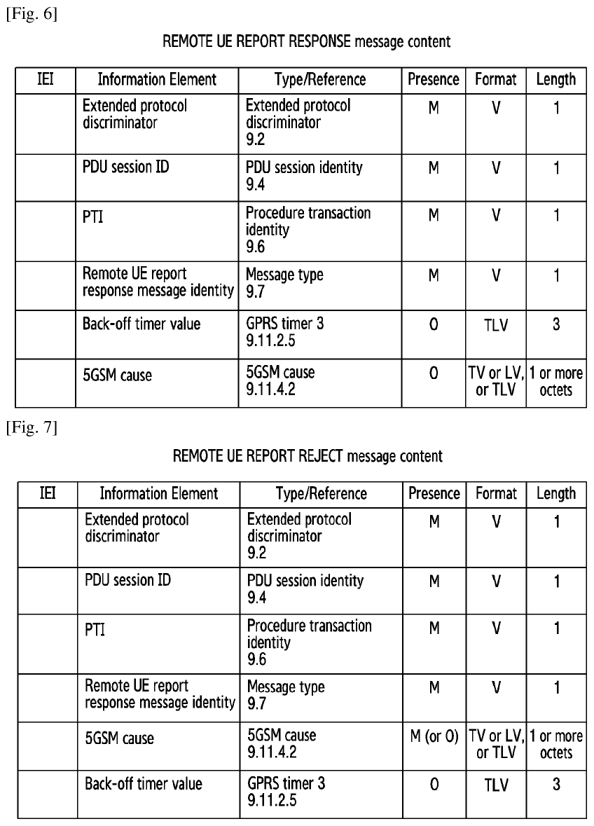

The prior art message, amended with a BO timer and a 5GSM cause as set out above, is shown in FIG. 6. Note that the position of the IEs in the message shown may be inter-changed.

A new message i.e. Remote UE Report Reject message with the BO timer and 5GSM cause, both/one of which can be optional IEs, is shown in FIG. 7.

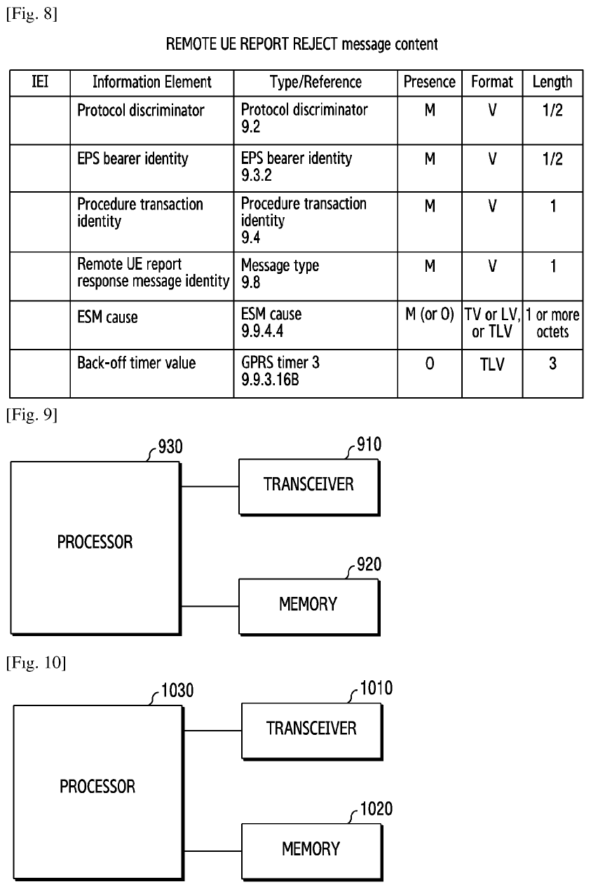

Note that the same procedures as set out above apply for the case of S1 mode where the MME may provide a BO timer to the UE and optionally an ESM cause in either the Remote UE Response message or in a new Remote UE Response Reject message. Similar messages as those defined in the previous section, for S1 mode, can also be used and may further include an ESM BO timer. The UE behaviour would generally be the same as the behaviour described above at least for timer T3396, which is a common timer in S1 mode and N1 mode. As such, all the steps set out above that were taken for 5GS (or N1 mode) would apply in a similar manner in S1 mode, However the different IEs or message names can be used correspondingly. For example, a new ESM message can be used to provide the UE with a BO timer as shown in FIG. 8.

Note that when the UE receives the Remote UE Report message, or the Remote UE Report Reject message, which includes a BO timer, the UE may either consider the procedure to have:
succeeded i.e. that the network has successfully process the contents of the Remote UE Report message despite providing a BO timer, or
rejected i.e. that the network has not processed the contents of the Remote UE Report message and as such the UE should resend the message (i.e. the Remote UE Report message) after the expiry of the related BO timer.

Option 2: in this option, the BO timer does not apply to the remote UE report procedure. As such, when the BO timer is running, the UE can send the Remote UE Report message but the UE should not send other messages (except for emergency services, or except for the current exceptions that are defined in TS 24.501 or TS 24.301). As such, in this option, when the UE wants to send an ESM message (in S1 mode), or a 5GSM message (in N1 mode), the UE should verify if a BO timer is running. If yes, the UE should verify the type of message that needs to be sent. If the message is a Remote UE Report message then the UE can send the message. If the message is not a Remote UE Report message then the UE refrains from sending the message unless the message is part of the exceptions defined in TS 24.501 or in TS 24.301 which are allowed to be sent when the BO timer is running (e.g. to report 3GPP PS data off or for emergency services).

In the case of N1 mode, when the UE determines to send the Remote UE Report message (according to option 2 above), the UE should not include the Request type IE in the UL NAS TRANSPORT message. This will help avoid the AMF from blocking the message and so the AMF would forward the 5GSM message to the SMF.

Note that the procedure set out above can also be extended to the mobility management BO timer e.g. T3346 which is applicable in S1 mode or N1 mode.

Similarly, when the UE is in 5GMM-IDLE/EMM-IDLE mode and needs to send the Remote UE Report message while the 5GMM/EMM BO timer is running, then the UE should verify if the NAS message is for a Remote UE Report or not. If yes, then the UE should send the message and hence the Remote UE Report message is considered to be an exception to the 5GMM/EMM BO timer for which the NAS message is allowed to be sent although the timer is running. If the UE determines that the NAS message is not a Remote UE Report, then the UE should not send the NAS message unless it is already listed as an exception to the BO timer as indicated in TS 24.510 or TS 24.301. As such, if the UE has a 5GMM/EMM BO timer that is running e.g. T3346, then the UE should act as described above in order to determine whether the NAS message is to be sent. In this solution, if T3346 is running and the UE which is in 5GMM-IDLE/EMM-IDLE mode needs to send a NAS message, then the UE should be allowed to first initiate the service request procedure (and send the Service Request message) if the UE needs to (e.g. subsequently) send the Remote UE Report message.

For the case of N1 mode, when the UE sends the Service Request message (although T3346 is running) because the UE needs to send the Remote UE Report message, then the UE may also set the Service type IE to “elevated signalling”.

Note that all the steps of the solutions described herein can be applied in any order and in any combination. Some are not limited to the UE being in EMM-IDLE or 5GMM-IDLE mode and can also apply in EMM-CONNECTED mode or 5GMM-CONNECTED mode.

FIG. 9 is a block diagram of an internal configuration of a base station, according to an embodiment as disclosed herein.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor.

The transceiver 910 collectively refers to a base station receiver and a base station transmitter, and may transmit/receive a signal to/from a terminal. The signal transmitted or received to or from the terminal may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal. The processor may referred to a controller.

FIG. 10 is a block diagram showing an internal structure of a terminal, according to an embodiment as disclosed herein.

As shown in FIG. 10, the terminal of the present disclosure may include a transceiver 1010, a memory 1010, and a processor 1030. The transceiver 1010, the memory 1010, and the processor 1030 of the terminal may operate according to a communication method of the terminal described above. However, the components of the terminal are not limited thereto. For example, the terminal may include more or fewer components than those described above. In addition, the processor 1030, the transceiver 1010, and the memory 1010 may be implemented as a single chip. Also, the processor 1030 may include at least one processor.

The transceiver 1010 collectively refers to a terminal receiver and a terminal transmitter, and may transmit/receive a signal to/from a base station. The signal transmitted or received to or from the base station may include control information and data. In this regard, the transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1010 may store a program and data required for operations of the terminal. Also, the memory 1010 may store control information or data included in a signal obtained by the terminal. The memory 1010 may be a storage medium, such as ROM, RAM, a hard disk, a CD-ROM, and a DVD, or a combination of storage media.

The processor 1030 may control a series of processes such that the terminal operates as described above. For example, the transceiver 1010 may receive a data signal including a control signal, and the processor 1030 may determine a result of receiving the data signal. The processor may referred to a controller.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the above particular embodiments of the disclosure, the components included in the disclosure are expressed in the singular or plural according to the presented particular embodiments of the disclosure. However, the singular or plural expressions are selected suitably according to the presented situations for convenience of description, the disclosure is not limited to the singular or plural components, and the components expressed in the plural may even be configured in the singular or the components expressed in the singular may even be configured in the plural.

While the disclosure has been shown and described with reference to various embodiments thereof, it will be understood by those skilled in the art that various changes in form and details may be made therein without departing from the spirit and scope of the disclosure as defined by the appended claims and their equivalents.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Although the present disclosure has been described with various embodiments, various changes and modifications may be suggested to one skilled in the art. It is intended that the present disclosure encompass such changes and modifications as fall within the scope of the appended claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-30. (canceled)

31. A method by a user equipment (UE), the method comprising:
determining to transmit a remote UE report message to a session management function (SMF) entity; and
identifying whether a back-off (BO) timer is running,
wherein a non access stratum (NAS) transport procedure for the remote UE report message is not started, in case that the BO timer is running.

32. The method of claim 31, wherein the remote UE report message includes a protocol data unit (PDU) session identification (ID).

33. The method of claim 32, further comprising:
receiving, from the SMF, a PDU session release command message indicating the PDU session ID included in the remote UE report message, during a UE report procedure related with the remote UE report message;
aborting the UE report procedure; and
proceeding a PDU session release procedure based on the PDU session release command message.

34. The method of claim 32, further comprising:
receiving, from the SMF, a 5G session management (5GSM) status message with cause information indicating that the PDU session ID is invalid, in case that a PDU session corresponding to the PDU session ID included in the remote UE report message is in state PDU session inactive in the SMF.

35. The method of claim 31, further comprising:
transmitting, to the SMF via the NAS transport procedure, the remote UE report message, after the BO timer stops or expires.

36. A method by a session management function (SMF) entity, the method comprising:
receiving, from a user equipment (UE) via a non access stratum (NAS) transport procedure, a remote UE report message including a protocol data unit (PDU) session identification (ID); and
transmitting, to the UE, a 5G session management (5GSM) status message with cause information indicating that the PDU session ID is invalid, in case that a PDU session corresponding to the PDU session ID included in the remote UE report message is in state PDU session inactive in the SMF.

37. The method of claim 36, further comprising
aborting a remote UE report procedure related with the remote UE report message, in case that the remote UE report message is received during a PDU session release procedure and the PDU session ID included the remote UE report message is included in a PDU session release command message; and
proceeding the PDU session release procedure based on the PDU session release command message,
wherein the PDU session release procedure includes transmitting, to the UE, the PDU session release command message including the PDU session ID.

38. The method of claim 36, further comprising:
transmitting, to the UE, a remote UE report response message, in case that no abnormal case is identified.

39. The method of claim 36,
wherein the NAS transport procedure for the remote UE report message is not started by the UE, in case that a back-off timer is running, and
wherein the remote UE report message is transmitted by the UE via the NAS transport procedure, after the BO timer stops or expires.

40. A user equipment (UE) comprising:
a transceiver; and
a controller coupled to the transceiver, the controller is configured to:
determine to transmit a remote UE report message to a session management function (SMF) entity, and
identify whether a back-off (BO) timer is running, and
wherein a non access stratum (NAS) transport procedure for the remote UE report message is not started, in case that the BO timer is running.

41. The UE of claim 40, wherein the remote UE report message includes a protocol data unit (PDU) session identification (ID).

42. The UE of claim 41, wherein the controller is further configured to:
receive, from the SMF, a PDU session release command message indicating the PDU session ID included in the remote UE report message, during a UE report procedure related with the remote UE report message;
abort the UE report procedure; and
proceed a PDU session release procedure based on the PDU session release command message.

43. The UE of claim 41, wherein the controller is further configured to:
receive, from the SMF, a 5G session management (5GSM) status message with cause information indicating that the PDU session ID is invalid, in case that a PDU session corresponding to the PDU session ID included in the remote UE report message is in state PDU session inactive in the SMF.

44. The UE of claim 40, wherein the controller is further configured to transmit, to the SMF via the NAS transport procedure, the remote UE report message, after the BO timer stops or expires.

45. A session management function (SMF) entity comprising:
a transceiver; and
a controller coupled to the transceiver, the controller is configured to:
receive, from a user equipment (UE) via a non access stratum (NAS) transport procedure, a remote UE report message including a protocol data unit (PDU) session identification (ID); and
transmit, to the UE, a 5G session management (5GSM) status message with cause information indicating that the PDU session ID is invalid, in case that a PDU session corresponding to the PDU session ID included in the remote UE report message is in state PDU session inactive in the SMF.

46. The SMF of claim 45, wherein the controller is further configured to:
abort a remote UE report procedure related with the remote UE report message, in case that the remote UE report message is received during a PDU session release procedure and the PDU session ID included the remote UE report message is included in a PDU session release command message; and
proceed the PDU session release procedure based on the PDU session release command message,
wherein the PDU session release procedure includes to transmit, to the UE, the PDU session release command message including the PDU session ID.

47. The SMF of claim 45, wherein the controller is further configured to transmit, to the UE, a remote UE report response message, in case that no abnormal case is identified.

48. The SMF of claim 45,
wherein the NAS transport procedure for the remote UE report message is not started by the UE, in case that a back-off timer is running, and
wherein the remote UE report message is transmitted by the UE via the NAS transport procedure, after the BO timer stops or expires.
